(19) United States
(12) Patent Application Publication
(10) Pub. No.: US 2021/0389344 A1
(43) Pub. Date: Dec. 16, 2021

(54) Inertia Sensor Apparatus And Method For Manufacturing Inertia Sensor Apparatus

(71) Applicant: Seiko Epson Corporation, Tokyo (JP)

(72) Inventor: Yasunori HIYOSHI, Suwa (JP)

(21) Appl. No.: 17/342,583

(22) Filed: Jun. 9, 2021

(30) Foreign Application Priority Data
Jun. 10, 2020 (JP) 2020-100715

(51) Int. Cl. G01P 15/18; G01P 15/08

(52) U.S. Cl. CPC G01P 15/18; G01P 15/08

(57) ABSTRACT

An inertia sensor apparatus includes a first sensor module including a first inertia sensor that outputs a first signal relating to a plurality of first detection axes and a first correction circuit that generates a first correction signal by correcting the first signal in such a way that the plurality of first detection axes are perpendicular to each other, a second sensor module including a second inertia sensor that outputs a second signal relating to a plurality of second detection axes and a second correction circuit that generates a second correction signal by correcting the second signal in such a way that the plurality of second detection axes are perpendicular to each other, a matching processor that generates a first matching signal by applying a first correction coefficient that causes the plurality of first detection axes to match with the plurality of second detection axes to the first correction signal, and a combining processor that combines the first matching signal with the second correction signal and outputs the combined signal.

The present application is based on, and claims priority from JP Application Serial Number 2020-100715, filed Jun. 10, 2020, the disclosure of which is hereby incorporated by reference herein in its entirety.

### BACKGROUND

### 1. Technical Field

The present disclosure relates to an inertia sensor apparatus and a method for manufacturing the inertia sensor apparatus.

### 2. Related Art

JP-A-2019-60689 discloses a physical quantity detection circuit that converts detection signals inputted via terminals coupled to a plurality of physical quantity detectors into voltage to generate a physical quantity signal carrying a noise component having small magnitude inversely proportional to the square root of the number of physical quantity detectors.

In the technology described in JP-A-2019-60689, however, when the detection axes of the plurality of physical quantity detectors deviate from each other, the accuracy of the detected physical quantity may deteriorate.

### SUMMARY

One aspect relates to an inertia sensor apparatus including a first sensor module including a first inertia sensor that outputs a first signal relating to a plurality of first detection axes and a first correction circuit that generates a first correction signal by correcting the first signal in such a way that the plurality of first detection axes are perpendicular to each other, a second sensor module including a second inertia sensor that outputs a second signal relating to a plurality of second detection axes and a second correction circuit that generates a second correction signal by correcting the second signal in such a way that the plurality of second detection axes are perpendicular to each other, a matching processor that generates a first matching signal by applying a first correction coefficient that causes the plurality of first detection axes to match with the plurality of second detection axes to the first correction signal, and a combining processor that combines the first matching signal with the second correction signal and outputs the combined signal.

Another aspect relates to an inertia sensor apparatus including a first sensor module including a first inertia sensor that outputs a first signal relating to a plurality of first detection axes and a first correction circuit that generates a first correction signal by correcting the first signal in such a way that the plurality of first detection axes are perpendicular to each other, a second sensor module including a second inertia sensor that outputs a second signal relating to a plurality of second detection axes and a second correction circuit that generates a second correction signal by correcting the second signal in such a way that the plurality of second detection axes are perpendicular to each other, a matching processor that generates a first matching signal by applying a first correction coefficient that causes the plurality of first detection axes to match with reference axes to the first correction signal and generates a second matching signal by applying a second correction coefficient that causes the plurality of second detection axes to match with the reference axes to the second correction signal, and a combining processor that combines the first matching signal with the second matching signal and outputs the combined signal.

Another aspect relates to a method for manufacturing an inertia sensor apparatus including a first sensor module including a first inertia sensor that outputs a first signal relating to a plurality of first detection axes and a first correction circuit that generates a first correction signal by correcting the first signal in such a way that the plurality of first detection axes are perpendicular to each other, a second sensor module including a second inertia sensor that outputs a second signal relating to a plurality of second detection axes and a second correction circuit that generates a second correction signal by correcting the second signal in such a way that the plurality of second detection axes are perpendicular to each other, a matching processor that generates a first matching signal by applying a first correction coefficient to the first correction signal, and a combining processor that combines the first matching signal with the second correction signal and outputs the combined signal, the method including calculating the first correction coefficient that causes the plurality of first detection axes to match with the plurality of second detection axes by comparing the first correction signal with gravitational acceleration and comparing the second correction signal with the gravitational acceleration.

Another aspect relates to a method for manufacturing an inertia sensor apparatus including a first sensor module including a first inertia sensor that outputs a first signal relating to a plurality of first detection axes and a first correction circuit that generates a first correction signal by correcting the first signal in such a way that the plurality of first detection axes are perpendicular to each other, a second sensor module including a second inertia sensor that outputs a second signal relating to a plurality of second detection axes and a second correction circuit that generates a second correction signal by correcting the second signal in such a way that the plurality of second detection axes are perpendicular to each other, a matching processor that generates a first matching signal by applying a first correction coefficient to the first correction signal and generates a second matching signal by applying a second correction coefficient to the second correction signal, and a combining processor that combines the first matching signal with the second matching signal and outputs the combined signal, the method including calculating the first correction coefficient that causes the plurality of first detection axes to match with reference axes by comparing the first correction signal with gravitational acceleration and calculating the second correction coefficient that causes the plurality of second detection axes to match with the reference axes by comparing the second correction signal with the gravitational acceleration.

### BRIEF DESCRIPTION OF THE DRAWINGS

FIG. 1 is a perspective view illustrating an inertia sensor apparatus according to an embodiment.

FIG. 2 is a plan view illustrating the interior of the inertia sensor apparatus.

FIG. 3 is an exploded perspective view illustrating a substrate and sensor modules.

FIG. 4 is an exploded perspective view showing a sensor module.

FIG. 5 is a top view showing a circuit substrate provided in the sensor module.

FIG. 6 is a bottom view of the circuit substrate shown in FIG. 5.

FIG. 7 is a block diagram illustrating the inertia sensor apparatus.

FIG. 8 is a block diagram illustrating the sensor module.

FIG. 9 is a flowchart illustrating a method of determining a correction coefficient.

FIG. 10 is a perspective view illustrating the inertia sensor apparatus according to a first variation of the embodiment.

FIG. 11 is a perspective view illustrating the inertia sensor apparatus according to a second variation of the embodiment.

FIG. 12 is a perspective view illustrating the inertia sensor apparatus according to a third variation of the embodiment.

### DESCRIPTION OF EXEMPLARY EMBODIMENTS

An embodiment of the present disclosure will be described below with reference to the drawings. The embodiment illustrates an apparatus and method for embodying the technical idea of the present disclosure. The technical idea of the present disclosure does not limit the material, shape, structure, arrangement, and other factors of each constituent part to those described below. In the drawings, the same or similar elements have the same or similar reference characters, and no duplicate description thereof will be made. The drawings are so schematically drawn as to contain dimensions, relative dimensional proportions, arrangements, structures, and other factors different from those in the actual implementation.

It is noted that the definition of the vertical direction and other directions described below is merely a definition for convenience of explanation and does not limit the technical idea of the present disclosure. For example, when an observation target is rotated by 90° around the line of sight, it is, of course, appreciated that the upper and lower sides of the observation target are converted into the left and right sides thereof, and that when the observation target is rotated by 180° around the line of sight, the upper and lower sides and the left and right sides of the observation target are reversed. The technical idea of the present disclosure can be changed in a variety of manners within the technical scope set forth in the appended claims.

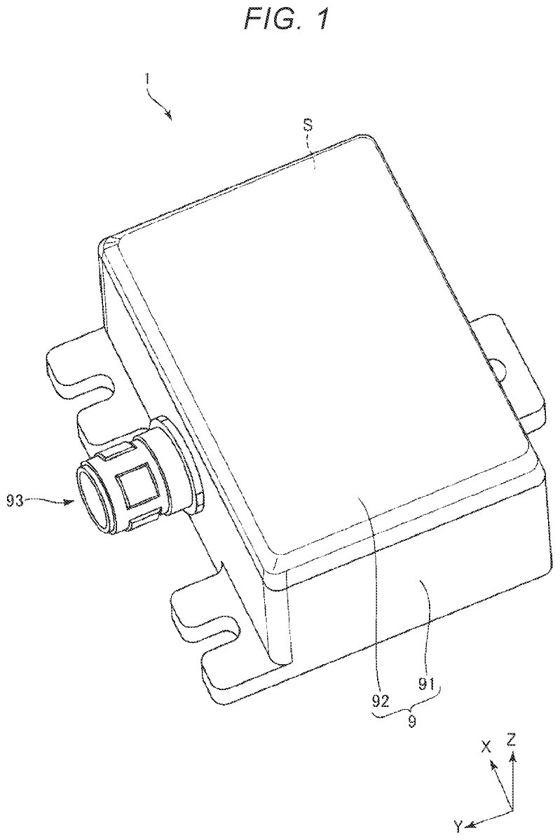

An inertia sensor apparatus 1 according to the embodiment includes, for example, a substrate 10, a first sensor module 2A, a second sensor module 2B, and a third sensor module 2C mounted on the substrate 10, a processing circuit 100, and a container 9, as shown in FIGS. 1 to 3. The inertia sensor apparatus 1 is a composite sensor unit including a plurality of inertia sensors that detect acceleration in the directions of three axes and angular velocity around the three axes. The inertia sensor apparatus 1 detects, for example, the motion state of a moving body, such as a vehicle, a robot, and a drone, an electronic instrument, such as a smartphone and a tablet terminal, and a variety of other targets. The motion state includes, for example, the position, posture, velocity, acceleration, and angular velocity.

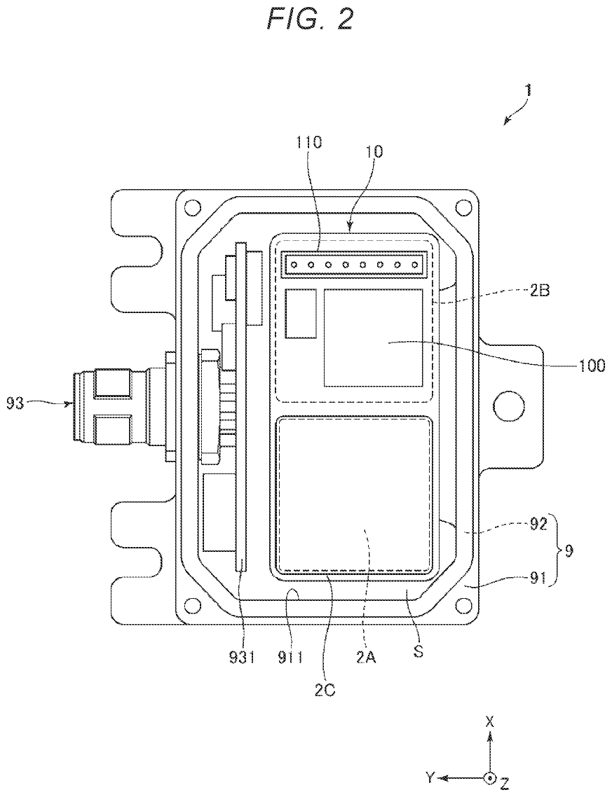

The container 9 includes a base 91 having a recess 911, which opens upward, and a lid 92 so fixed to the base 91 as to close the opening of the recess 911, as shown in FIGS. 1 and 2. The container 9 schematically has the shape of a rectangular flat plate. The base 91 and the lid 92 define an accommodation space S inside the recess 911 sealed by the lid 92. The accommodation space S is a space for accommodating the substrate 10, the first sensor module 2A, the second sensor module 2B, the third sensor module 2C, the processing circuit 100, and other parts. The container 9 protects the parts accommodated in the accommodation space S from dust, moisture, ultraviolet rays, impact, and the like.

The base 91 and lid 92 may be made of aluminum (Al). In addition, employable examples of the materials of the base 91 and the lid 92 include metal materials, such as Al alloy, zinc (Zn), and stainless steel, a variety of types of ceramic, a variety of resin materials, and composite materials thereof.

The inertia sensor apparatus 1 includes a connector 93 attached to the side wall of the base 91 and a communication substrate 931 disposed in the accommodation space S. The connector 93 is a receptacle that electrically couple the interior and the exterior of the container 9 to each other. The communication substrate 931 includes a circuit that processes communication between the inertia sensor apparatus 1 and another apparatus.

The substrate 10 is a circuit substrate including a variety of elements and wiring lines. The first sensor module 2A, the second sensor module 2B, the third sensor module 2C, the processing circuit 100, an internal connector 110, and other components are mounted on the substrate 10. The substrate 10 is relatively fixed, for example, to the base 91.

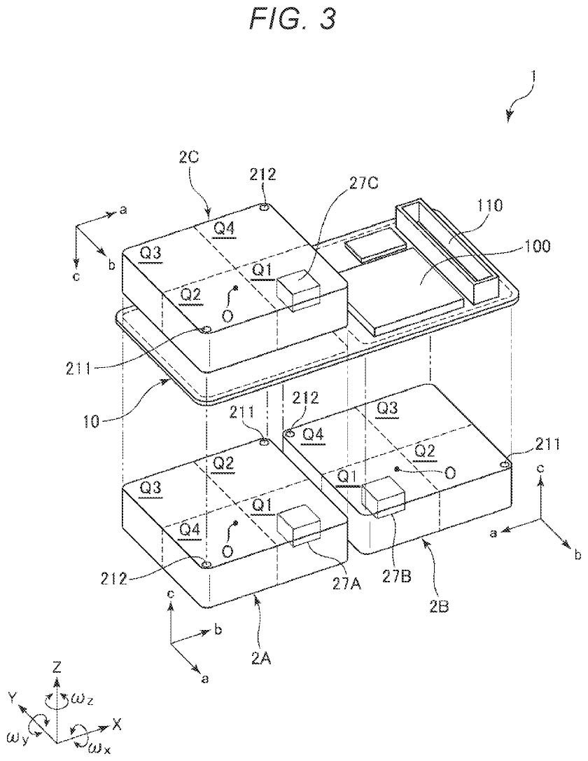

The first sensor module 2A and the second sensor module 2B are arranged along an axis X on the lower surface of the substrate 10, as shown in FIGS. 2 and 3. The third sensor module 2C is so disposed on the upper surface of the substrate 10 as to overlap with the first sensor module 2A when viewed in the direction along an axis Z. The processing circuit 100 and the internal connector 110 are so disposed on the upper surface of the substrate 10 as to overlap with the second sensor module 2B when viewed in the direction along the axis Z. The efficient arrangement of the variety of parts that are arranged in the area of the substrate 10 and the accommodation space S allows reduction in size of the inertia sensor apparatus 1.

The first sensor module 2A, the second sensor module 2B, and the third sensor module 2C are coupled to the processing circuit 100 via the substrate 10. The processing circuit 100 controls the operation of driving the first sensor module 2A, the second sensor module 2B, and the third sensor module 2C. The processing circuit 100 is coupled to the communication substrate 931 via the internal connector 110 and wiring that is not shown but is coupled to the internal connector 110.

The first sensor module 2A, the second sensor module 2B, and the third sensor module 2C have, for example, the same structure. In the following description, any of the first sensor module 2A, the second sensor module 2B, and the third sensor module 2C is simply referred to as a “sensor module 2,” and redundant description of the others will be omitted. The number of sensor modules 2 is not limited to three and may be two or four or more.

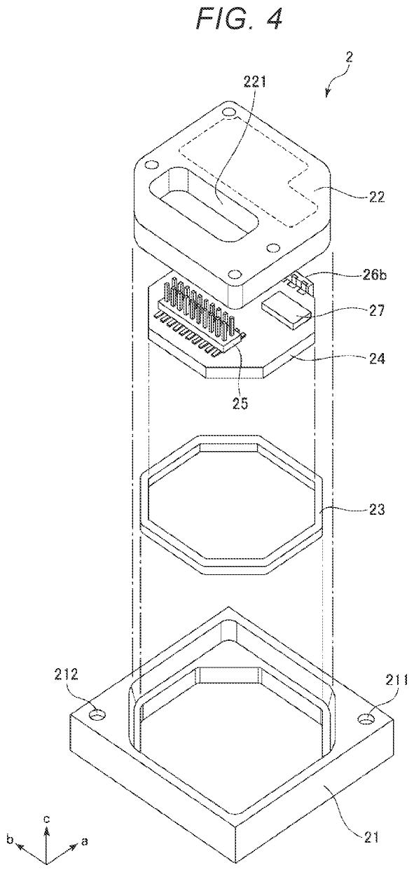

The sensor module 2 includes an outer enclosure 21, an inner enclosure 22, a joint member 23, and a circuit substrate 24, as shown in FIG. 4. The outer enclosure 21 has a recess into which the inner enclosure 22 is inserted. The outer enclosure 21 and the inner enclosure 22 are joined to each other via the joint member 23 with the circuit substrate 24 accommodated in and held by the enclosures. The sensor module 2 has a square shape when viewed from above, that is, in the direction along an axis c shown in FIG. 4. The outer enclosure 21 has, for example, screw holes 211 and 212 provided at a pair of corners located on a diagonal of the upper surface thereof. The sensor module 2 can be fixed to the substrate 10 with screws screwed into the screw holes 211 and 212.

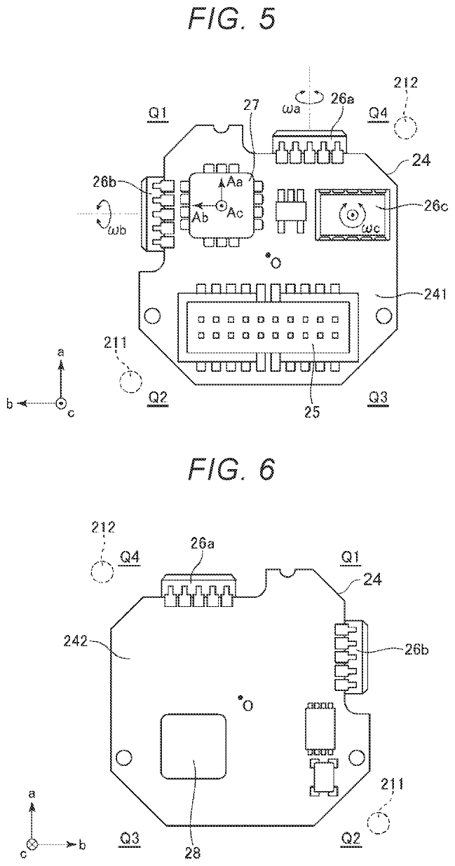

A module connector 25, a first angular velocity sensor 26a, a second angular velocity sensor 26b, a third angular velocity sensor 26c, an acceleration sensor 27, a correction circuit 28, and other components are mounted on the circuit substrate 24, as shown in FIGS. 5 and 6. The module connector 25 couples the sensor module 2 to the substrate 10. The module connector 25 is exposed to the substrate 10 through, for example, an opening 221 provided in the inner enclosure 22. The first angular velocity sensor 26a detects angular velocity ωa around an axis a. The second angular velocity sensor 26b detects angular velocity ωb around an axis b. The third angular velocity sensor 26c detects angular velocity ωc around the axis c. The acceleration sensor 27 detects acceleration Aa in the direction along the axis a, acceleration Ab in the direction along the axis b, and acceleration Ac in the direction along the axis c. The three detection axes a, b, and c are defined for each sensor module 2.

The correction circuit 28 is formed, for example, of an integrated circuit (IC). The correction circuit 28 is coupled to each of the first angular velocity sensor 26a, the second angular velocity sensor 26b, the third angular velocity sensor 26c, and the acceleration sensor 27 via the circuit substrate 24. The correction circuit 28 is coupled to the processing circuit 100 via the circuit substrate 24, the module connector 25, the substrate 10, and other components.

The circuit substrate 24 has, for example, a square shape when viewed in the direction along the axis c. Four quadrants defined around the center O of the circuit substrate 24 are called a first quadrant Q1, a second quadrant Q2, a third quadrant Q3, and a fourth quadrant Q4, and the acceleration sensor 27 is disposed in the first quadrant Q1. The first sensor module 2A, the second sensor module 2B, and the third sensor module 2C are so arranged that the first quadrants Q1 thereof are close to each other, as shown in FIG. 3.

That is, in the example shown in FIG. 3, an acceleration sensor 27A in the first sensor module 2A and an acceleration sensor 27C in the third sensor module 2C are so arranged as to overlap with each other when viewed in the direction along the axis Z. The acceleration sensor 27A in the first sensor module 2A and an acceleration sensor 27B in the second sensor module 2B are so arranged as to overlap with each other when viewed in the direction along the axis X. Differences in received acceleration among the acceleration sensor 27A, the acceleration sensor 27B, and the acceleration sensor 27C can thus be suppressed to a small value.

The module connector 25 is disposed on an upper surface 241 of the circuit substrate 24 in the second quadrant Q2 and the third quadrant Q3. The first angular velocity sensor 26a is disposed on the side surface of the circuit substrate 24 in the fourth quadrant Q4. The second angular velocity sensor 26b is disposed on the side surface of the circuit substrate 24 in the first quadrant Q1. The third angular velocity sensor 26c is disposed on the upper surface 241 of the circuit substrate 24 in the fourth quadrant Q4. The acceleration sensor 27 is disposed on the upper surface 241 of the circuit substrate 24 in the first quadrant Q1. The correction circuit 28 is disposed on a lower surface 242 of the circuit substrate 24 in the third quadrant Q3. The screw hole 211 is disposed in the second quadrant Q2, and the screw hole 212 is disposed in the fourth quadrant Q4.

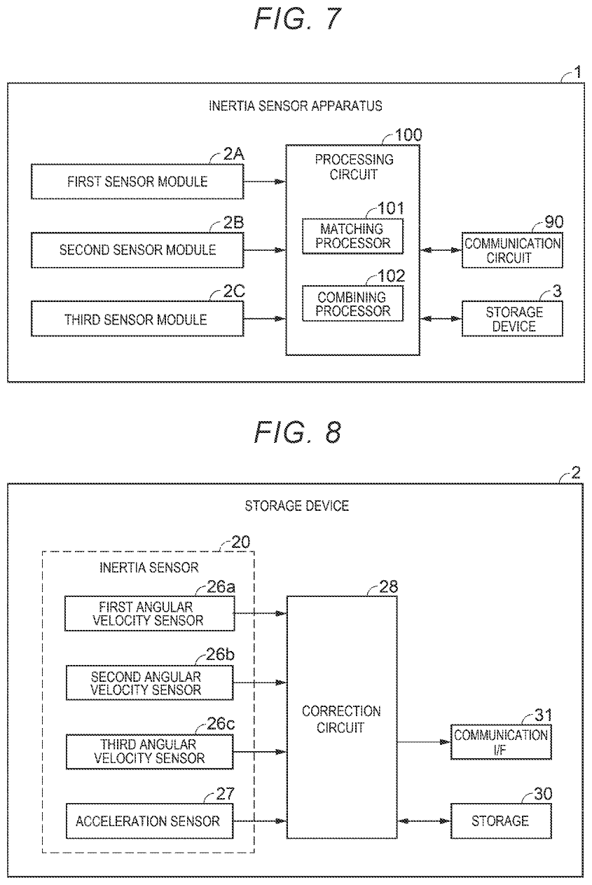

The inertia sensor apparatus 1 further includes a communication circuit 90 and a storage device 3 in addition to the first sensor module 2A, the second sensor module 2B, the third sensor module 2C, and the processing circuit 100, as shown in FIG. 7. The communication circuit 90 is implemented, for example, on the communication substrate 931. The communication substrate 931 outputs, for example, inertia data calculated in the processing circuit 100 to the other apparatus.

The processing circuit 100 has a matching processor 101 and a combining processor 102 as a logical structure. Employable examples of circuits that form at least part of the processing circuit 100 include a variety of logical operation circuits, such as an A/D converter and other signal processing circuits, a microcontroller unit (MCU) , and an application specific integrated circuit (ASIC). The storage device 3 is a nonvolatile storage device, for example, a semiconductor memory. The processing circuit 100 and the storage device 3 may be formed of an integrated hardware component or a plurality of separate hardware components.

The sensor module 2 includes an inertia sensor 20 including at least any of the first angular velocity sensor 26a, the second angular velocity sensor 26b, the third angular velocity sensor 26c, and the acceleration sensor 27, the correction circuit 28, a communication interface (I/F) 31, and a storage 30, as shown in FIG. 8. The communication I/F 31 includes the module connector 25. The storage 30 stores, for example, a variety of parameters used for correction performed in the correction circuit 28.

The inertia sensor 20 outputs signals relating to the plurality of detection axes to the correction circuit 28. The correction circuit 28 generates a correction signal by correcting the signals outputted from the inertia sensor 20 in such a way that the plurality of detection axes are perpendicular to one another. For example, the plurality of detection axes that form a three-dimensional orthogonal coordinate system are set for each sensor module 2. In addition, the correction circuit 28 corrects an offset error and a scale factor error contained in each of the signals inputted from the inertia sensor 20.

In the following description, the inertia sensor 20 provided in an n-th sensor module, which is any of the first sensor module 2A, the second sensor module 2B, and the third sensor module 2C, is called an n-th inertia sensor. Similarly, the correction circuit 28 provided in the n-th sensor module is called an n-th correction circuit. The detection axes set in the n-th sensor module are called n-th detection axes. The signal relating to a plurality of n-th detection axes is called an n-th signal, and the n-th signal so corrected that the plurality of n-th detection axes are perpendicular to each other is called an n-th correction signal.

For example, in the example shown in FIG. 8, when the sensor module 2 is the first sensor module 2A, the inertia sensor 20 corresponds to a first inertia sensor that outputs a first signal relating to a plurality of first detection axes. The correction circuit 28 corresponds to a first correction circuit that generates a first correction signal by correcting the first signal in such a way that the plurality of first detection axes are perpendicular to one another. Similarly, when the sensor module 2 is the second sensor module 2B, the inertia sensor 20 corresponds to a second inertia sensor that outputs a second signal relating to a plurality of second detection axes. The correction circuit 28 corresponds to a second correction circuit that generates a second correction signal by correcting the second signal in such a way that the plurality of second detection axes are perpendicular to one another.

The signals outputted by the inertia sensor 20 typically each have misalignment that is angular errors of the plurality of detection axes due, for example, to angular shifts at the time of assembly. The correction circuit 28 therefore generates a correction signal by performing misalignment correction in which a correction coefficient, such as a rotation matrix determined in advance, is applied to the signals from the inertia sensor 20. The correction circuit 28 outputs the correction signal to the processing circuit 100 via the communication I/F 31.

The matching processor 101 generates a first matching signal, for example, by applying a first correction coefficient that causes the plurality of first detection axes to match with the plurality of second detection axes to the first correction signal. That is, the first correction coefficient is a coefficient for eliminating the misalignment of the first correction signal with the second correction signal. The first correction coefficient is a coefficient that causes the plurality of first detection axes in the first correction signal to rotate so as to coincide with reference axes that are the plurality of second detection axes. The first correction coefficient may be any one of a rotation matrix, a Eulerian angle, and a quaternion. The first correction coefficient is stored in the storage device 3 in advance.

The combining processor 102 combines the first matching signal generated by the matching processor 101 with the second correction signal outputted from the second sensor module and outputs the combined signal. In detail, the combining processor 102 generates inertia data by combining the first matching signal with the second correction signal and outputs the inertia data to an external apparatus via the communication circuit 90.

The matching processor 101 may further generate a third matching signal, for example, by applying a third correction coefficient that causes a plurality of third detection axes to match with the plurality of second detection axes to a third correction signal. The third correction coefficient is a coefficient that causes the plurality of third detection axes in the third correction signal to rotate so as to coincide with the plurality of second detection axes. The third correction coefficient is stored in the storage device 3 in advance. In this case, the combining processor 102 generates inertia data by combining the first matching signal, the second correction signal, and the third matching signal with one another and outputs the inertia data.

As described above, the inertia sensor apparatus corrects, for example, the first correction signal outputted from the first sensor module 2A in such a way that the detection axes of any sensor module 2 match with the detection axes of another sensor module 2. The deviation of the detection axes among the plurality of sensor modules 2 is thus eliminated, whereby deterioration of the accuracy of the detected inertia data can be suppressed. Further, since the signals from the plurality of sensor modules 2 are combined with one another, random noise can be reduced, whereby the S/N ratio can be improved.

The matching processor 101 may instead cause the detection axes of the plurality of sensor modules 2 to match with other reference axes. For example, the matching processor 101 generates the first matching signal by applying the first correction coefficient that causes the plurality of first detection axes to match with predetermined reference axes to the first correction signal outputted from the first sensor module 2A. In this case, the first correction coefficient is a coefficient for eliminating the misalignment of the first correction signal with the reference axes. That is, the first correction coefficient is a coefficient that causes the plurality of first detection axes in the first correction signal to rotate so as to coincide with the reference axes. The reference axes may be the axes of the orthogonal coordinate system set in advance for each inertia sensor apparatus 1, for example, the three axes, X, Y, and Z set for the substrate 10 as shown in FIGS. 1 to 3.

Similarly, the matching processor 101 generates a second matching signal by applying a second correction coefficient that causes the plurality of second detection axes to match with the reference axes to the second correction signal outputted from the second sensor module 2B. In this case, the second correction coefficient is a coefficient that causes the plurality of second detection axes to rotate so as to coincide with the reference axes. The first correction coefficient and the second correction coefficient are stored in the storage device 3 in advance.

The combining processor 102 combines the first matching signal and the second matching signal generated by the matching processor 101 with each other and outputs the combined signal. In detail, the combining processor 102 generates inertia data by combining the first matching signal and the second matching signal and outputs the inertia data to the external apparatus via the communication circuit 90.

The matching processor 101 may further generate the third matching signal by applying the third correction coefficient that causes the plurality of third detection axes to match with the reference axes to the third correction signal. The third correction coefficient is a coefficient that causes the plurality of third detection axes in the third correction signal to rotate so as to coincide with the reference axes. The third correction coefficient is stored in the storage device 3 in advance. In this case, the combining processor 102 generates inertia data by combining the first matching signal, the second matching signal, and the third matching signal with one another and outputs the inertia data.

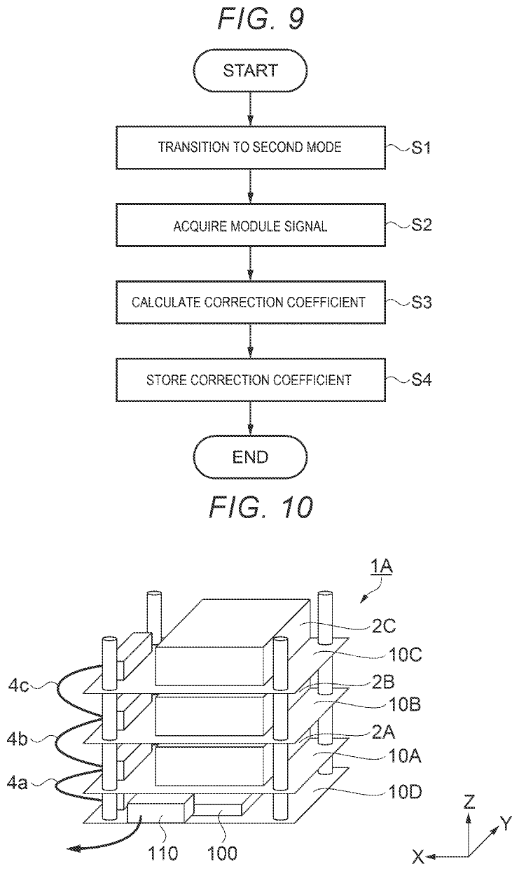

An example of a method for determining the correction coefficient will be described as a method for manufacturing the inertia sensor device 1 according to the embodiment with reference to the flowchart of FIG. 9. The matching processor 101 has a first mode in which the matching signal generated by applying the correction coefficient to the correction signal outputted from the sensor module 2 is outputted and a second mode in which the correction signal outputted from the sensor module 2 is outputted by causing it to pass through as it is.

Determination of the first correction coefficient based on the first correction signal outputted from the first sensor module 2A will be described below by way of example. The first sensor module 2A is first, as a prerequisite, so set as to take a reference posture. Employable examples of the reference posture include a first posture in which the axis Z of the sensor module 2A coincides with the direction of gravity and a second posture in which the axis X of the sensor module 2A coincides with the direction of gravity. The reference posture is, for example, a posture taken when a predetermined surface of the container 9 is placed on a horizontal surface.

In step S1, the processing circuit 100 transitions to the second mode. The transition to the second mode may be performed, for example, in response to a command received from the other apparatus via the communication circuit 90 or in response to operation performed on a switch provided at the circuit substrate 24. The matching processor 101 can output the first correction signal in the second mode by applying an identity element in place of the first correction coefficient to the first correction signal inputted from the first sensor module 2A. The identity element is, for example, an identity matrix when the first correction signal is a matrix.

In step S2, the processing circuit 100 acquires the first correction signal outputted from the matching processor 101 as a module signal. In step S3, the processing circuit 100 calculates the first correction coefficient that causes the plurality of first detection axes to match with the reference axes by comparing the first correction signal with the gravitational acceleration. The reference axes may be a plurality of second detection axes or may be another reference axis set, for example, for the substrate 10. The reference axes may be the plurality of second detection axes or other reference axes set, for example, for the substrate 10. For example, when the acceleration that should be ideally measured in the reference posture is the gravitational acceleration, the value resulting from the application of the first correction coefficient to the first correction signal, which is a measured value, is the gravitational acceleration, whereby the first correction coefficient can be calculated from the gravitational acceleration and the first correction signal.

In step S4, the processing circuit 100 causes the storage device 3 to store the first correction coefficient calculated in step S3. The first correction coefficient stored in the storage device 3 is used by the matching processor 101 to generate the first matching signal. The first correction coefficient in the inertia sensor apparatus 1 is thus determined.

Similarly, to determine the second correction coefficient, the matching processor 101 applies an identity element to the second correction signal and outputs the result of the application in the second mode. The processing circuit 100 calculates the second correction coefficient that causes the plurality of second detection axes to match with the reference axes by comparing the second correction signal with the gravitational acceleration. The second correction coefficient is stored in the storage device 3 and used by the matching processor 101 to generate the second matching signal.

The case where the processing circuit 100 carries out the processes in steps S2 to S4 has been described, and an external computer apparatus may instead carry out the processes. For example, in step S2, the matching processor 101 outputs a correction signal outputted from a target sensor module 2 via the connector 93 or the internal connector 110 to the external apparatus. The external apparatus then calculates a correction coefficient. The correction signal may instead be outputted by causing it to pass through, for example, a logic circuit in the second mode. As described above, the matching processor 101, which has the second mode, can calculate a correction coefficient without requiring a dedicated structure for outputting a correction signal.

The embodiment has been described above, but the present disclosure is not limited to the disclosed embodiment. The configuration of each portion may be replaced with an arbitrary configuration having the same function, and an arbitrary configuration in the embodiment may be omitted or added within the technical scope of the present disclosure. The disclosure of such replacement, omission, and addition thus allows a person skilled in the art to conceive of a variety of alternative embodiments.

For example, an inertia sensor apparatus 1A according to a first variation includes the first sensor module 2A, the second sensor module 2B, and the third sensor module 2C stacked on each other in one direction, that is, the direction along the axis Z, as shown in FIG. 10. The inertia sensor apparatus 1A further includes four substrates 10A, 10B, 10C, and 10D and the processing circuit 100 and the internal connector 110 each mounted on the substrate 10D. The substrates 10A to 10D are fixed relative to each other. The first sensor module 2A is mounted on the substrate 10A. The second sensor module 2B is mounted on the substrate 10B. The third sensor module 2C is mounted on the substrate 10C.

The first sensor module 2A, the second sensor module 2B, and the third sensor module 2C are coupled to the processing circuit 100 in a daisy chain scheme via a plurality of cables 4a, 4b, and 4c. The cables 4a, 4b, and 4c couple the first sensor module 2A, the second sensor module 2B, the third sensor module 2C, and the processing circuit 100 to each other, for example, via connectors mounted on the substrates 10A, 10B, and 10C. Coupling the sensor modules 2 in series to each other as described above allows improvement in the degree of freedom in design and readily allows an increase in the number of sensor modules. The S/N ratio of the output signal from the inertia sensor apparatus 1A can thus be further improved.

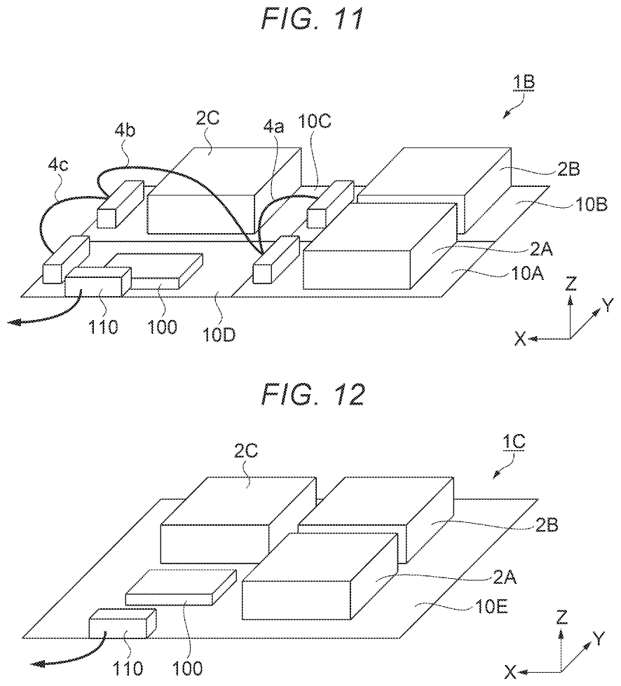

Instead, an inertia sensor apparatus 1B according to a second variation includes the first sensor module 2A, the second sensor module 2B, and the third sensor module 2C arranged in the same plane, as shown in FIG. 11. The inertia sensor apparatus 1B includes the substrates 10A to 10D arranged in a single plane along the plane XY. As in the example shown in FIG. 10, the first sensor module 2A, the second sensor module 2B, and the third sensor module 2C are coupled to the processing circuit 100 in a daisy chain scheme via the plurality of cables 4a, 4b, and 4c. Therefore, the degree of freedom in design is improved, and the number of sensor modules can be readily increased.

An inertia sensor apparatus 1C according to a third variation includes a single substrate 10E in place of the plurality of substrates 10A to 10D arranged in the same plane, as shown in FIG. 12. The first sensor module 2A, the second sensor module 2B, the third sensor module 2C, the processing circuit 100, and the internal connector 110 are mounted on the substrate 10E. The substrate 10E includes wiring that couples the first sensor module 2A, the second sensor module 2B, the third sensor module 2C, and the processing circuit 100 to each other. The processing circuit 100 is, for example, coupled in parallel to each sensor module 2. The communication capacity can thus be used efficiently as compared with that in the serial wiring.

The functions of the processing circuit 100 may be achieved by the correction circuit 28. That is, a correction signal generated by the correction circuit 28 of each sensor module 2 may be converted into a matching signal by using a correction coefficient stored in the storage 30 in advance. In addition, the correction circuit 28 of any sensor module 2 may be used as a master, and a correction signal or a matching signal inputted from another sensor module 2 may be combined with each other by the master correction circuit 28.

In addition to the above, the present disclosure, of course, encompasses a variety of embodiments that are not described above, such as a configuration to which the configurations described above are mutually applied. The technical scope of the present disclosure is specified only by the inventive specific items according to the appended claims reasonably derived from the above description.

What is claimed is:

1. An inertia sensor apparatus comprising:
a first sensor module including a first inertia sensor that outputs a first signal relating to a plurality of first detection axes and a first correction circuit that generates a first correction signal by correcting the first signal in such a way that the plurality of first detection axes are perpendicular to each other;
a second sensor module including a second inertia sensor that outputs a second signal relating to a plurality of second detection axes and a second correction circuit that generates a second correction signal by correcting the second signal in such a way that the plurality of second detection axes are perpendicular to each other;
a matching processor that generates a first matching signal by applying a first correction coefficient that causes the plurality of first detection axes to match with the plurality of second detection axes to the first correction signal; and
a combining processor that combines the first matching signal with the second correction signal and outputs the combined signal.

2. An inertia sensor apparatus comprising:
a first sensor module including a first inertia sensor that outputs a first signal relating to a plurality of first detection axes and a first correction circuit that generates a first correction signal by correcting the first signal in such a way that the plurality of first detection axes are perpendicular to each other;
a second sensor module including a second inertia sensor that outputs a second signal relating to a plurality of second detection axes and a second correction circuit that generates a second correction signal by correcting the second signal in such a way that the plurality of second detection axes are perpendicular to each other;
a matching processor that generates a first matching signal by applying a first correction coefficient that causes the plurality of first detection axes to match with reference axes to the first correction signal and generates a second matching signal by applying a second correction coefficient that causes the plurality of second detection axes to match with the reference axes to the second correction signal; and
a combining processor that combines the first matching signal with the second matching signal and outputs the combined signal.

3. The inertia sensor apparatus according to claim 1, wherein the matching processor has a first mode in which the first matching signal is outputted and a second mode in which the first correction signal is outputted.

4. The inertia sensor apparatus according to claim 3, wherein the matching processor applies an identity element to the first correction signal and outputs a resultant signal in the second mode.

5. The inertia sensor apparatus according to claim 1, wherein the first correction coefficient is any one of a rotation matrix, a Eulerian angle, and a quaternion.

6. A method for manufacturing an inertia sensor apparatus including
a first sensor module including a first inertia sensor that outputs a first signal relating to a plurality of first detection axes and a first correction circuit that generates a first correction signal by correcting the first signal in such a way that the plurality of first detection axes are perpendicular to each other,
a second sensor module including a second inertia sensor that outputs a second signal relating to a plurality of second detection axes and a second correction circuit that generates a second correction signal by correcting the second signal in such a way that the plurality of second detection axes are perpendicular to each other,
a matching processor that generates a first matching signal by applying a first correction coefficient to the first correction signal, and
a combining processor that combines the first matching signal with the second correction signal and outputs the combined signal,
the method comprising calculating the first correction coefficient that causes the plurality of first detection axes to match with the plurality of second detection axes by comparing the first correction signal with gravitational acceleration and comparing the second correction signal with the gravitational acceleration.
